(19) United States
(12) Patent Application Publication
(10) Pub. No.: US 2008/0235189 A1
(43) Pub. Date: Sep. 25, 2008

(54) SYSTEM FOR SEARCHING FOR INFORMATION BASED ON PERSONAL INTERACTIONS AND PRESENCES AND METHODS THEREOF

(76) Inventors: Drew Rayman, Pleasantville, NY (US); Brad Alperin, Brooklyn, NY (US); Timothy Driscoll, New York, NY (US); Stuart Goldstein, Millwood, NY (US); David Levin, New York, NY (US); Benjamin Simon, New York, NY (US)

Correspondence Address: BLANK ROME LLP, 600 NEW HAMPSHIRE AVENUE, N.W., WASHINGTON, DC, 20037, US

(21) Appl. No.: 11/855,851

(22) Filed: Sep. 14, 2007

Related U.S. Application Data
(60) Provisional application No. 60/907,159, filed on Mar. 23, 2007.

(51) Int. Cl. G06F 17/30

(52) U.S. Cl. 707/3; 707/E17.108

(57) ABSTRACT

A method and system of searching for information on a network includes receiving a search query from a user by a search system, processing the search query by a profile engine of the search system, providing a listing of search results, including personas who know about the search query, based on profiles and posts of the personas, where the personas are users of the search system, and facilitating further interaction with the listing of personas and tags for related content.

### CROSS-REFERENCE TO RELATED APPLICATIONS

This application claims the benefit of U.S. Provisional Patent Application No. 60/907,159, filed on Mar. 23, 2007. The full disclosure of that provisional application is incorporated herein by reference.

### FIELD OF THE INVENTION

The present invention is directed to information searching systems. More specifically, the present invention is further directed to systems and methods that allow for the searching of information based on personal interactions with other users.

### DESCRIPTION OF RELATED ART

The use of search engines in today's online world is extremely prevalent and important to many aspects of life. Where earlier generations required many painstaking hours to obtain information about a given topic, today's search engines give the searcher an unparalleled view into the jungle of content available on the web and other media. Search engines correct misspellings, make intelligent suggestions, and ultimately help the search to locate that single desired piece of relevant information. One of the most important aspects of the growth of online activity has been the ability for users to obtain information that they could not readily and easily obtain offline.

However, current search engines are limited to a single source of data: content physically published on the web. Other sources, such as the experiences and the interests of the users may not be readily apparent or searchable. The user's knowledge is content that can't be indexed by online search engines, and online search engines do not tag or explore the user's experiences and/or passions.

Thus, if a user searches, for example, for the specifications on a 400-horsepower motorcycle, online search engines may provide numerous examples. However, there is no easy way for links to be provided to someone who can describe what it's like to slam the throttle or particulars in repairing such a motorcycle. A search engine may be able to provide a recipe for a particular dish and perhaps even a picture of the dish, but does not provide a direct means of interacting with someone who has actually prepared the dish, who could supply information about how the dish could be made spicy or bland, for example.

Therefore, there is a need in the prior art for a system and method that allows users to search for information and obtain more than just basic facts. There is also a need for a system that provides for interaction based on a searcher's need where such interaction would not be guided by prior experience of the searcher. Further, there is a need to determine the presence of those persons who can provide the additional insights and convey their availability to interact.

### SUMMARY OF THE INVENTION

It is thus an object of the present invention to provide a system that allows users to search for information and obtain more than just basic facts. Another object of the present invention is to provide a system for interaction based on a searcher's need where such interaction would not be guided by prior experience of the searcher. Another object of the present invention is to determine the presence of those persons who can provide the additional insights and convey their availability to interact.

To achieve the above and other objects, the present invention is directed to a method of searching for information on a network that includes receiving a search query from a user by a search system, processing the search query by a profile engine of the search system, providing a listing of search results, including personas who know about the search query, based on profiles and posts of the personas, where the personas are users of the search system and facilitating further interaction with the listing of personas and tags for related content.

Preferably, the step of providing the listing of personas may also include providing a listing of personas ranked by computed relevance to the search query or providing a listing of personas ranked by presence statuses of the personas in the listing of personas. The system may also provide a relevant listing of posts of the personas relevant to the search query. The method may also include awaiting a selection of a particular persona from the listing of personas by the user and displaying information and contact actions for the particular persona to the user. The contact actions may include at least one of chat, instant messaging, voice-over-IP and telephonic communication. In addition, the content of the interactions between users is captured and that new content is integrated into the search indices so that the overall knowledge base is extended in an automated fashion.

The method may also include providing an interactive rating listing for the found personas to allow the user to rate a particular persona. Also, the user may be served with an element that promotes attributes of a particular persona based on the search query, where that element may be an ad promoting the particular persona and the attributes of the particular persona may include at least one of availability of the particular persona and specific knowledge of the particular persona. Information about the search query and the listing of search results may also be provided to a persona based on pre-selected criteria setup by the persona.

The present invention is also directed to a computer program product, embodied on a computer-readable medium, that includes instructions for performing the steps of receiving a search query from a user by a search system, processing the search query by a profile engine of the search system, providing a listing of search results, including personas who know about the search query, based on profiles and posts of the personas, where the personas are users of the search system and facilitating further interaction with the listing of personas and tags for related content.

The present invention is also directed to a system providing a user with the ability to search for information on a network. The system includes an interface for receiving a search query from a user and for providing a listing of search results back to the user and a search processor configured to process the search query through a profile engine. The system also includes a database, including a listing of personas who are users of the system and attributes of the personas, based on profiles and posts of the personas and an interaction mediator, which facilitates interaction between the user performing the search query and the personas. The search results comprise a listing of personas who know about the subject of the search query and tags for related content.

### BRIEF DESCRIPTION OF THE DRAWINGS

A preferred embodiment of the present invention will be set forth in detail with reference to the drawings, in which:

FIG. 1 is a schematic which illustrates the system architecture of the search system, according to at least one embodiment of the present invention;

FIG. 2 is a Unified Modeling Language (UML) diagram illustrating the use of ratings in the system, according to at least one embodiment of the present invention;

FIG. 3 is a Unified Modeling Language (UML) diagram illustrating the use of a control panel to assist a user, according to at least one embodiment of the present invention;

FIG. 4 is a Unified Modeling Language (UML) diagram illustrating the serving of ads based on presence, according to at least one embodiment of the present invention;

FIG. 5 is a Unified Modeling Language (UML) diagram illustrating the search monitoring process, according to at least one embodiment of the present invention; and

FIG. 6 illustrates the relationships between tags used in the search system, according to at least one embodiment of the present invention.

### DETAILED DESCRIPTION OF THE PREFERRED EMBODIMENT

A preferred embodiment of the present invention will be set forth in detail with reference to the drawings, in which like reference numerals refer to like elements or operational steps throughout.

The present invention is directed to a system which allows users to search for information and rate the information and users of the system. The present invention is also directed to a system which allows users to connect with other people by bridging the divide between their networks. The description of the system is broken down into separate areas below, including: system architecture, the rating system, the control panel, serving elements of the system based on presence and search monitoring.

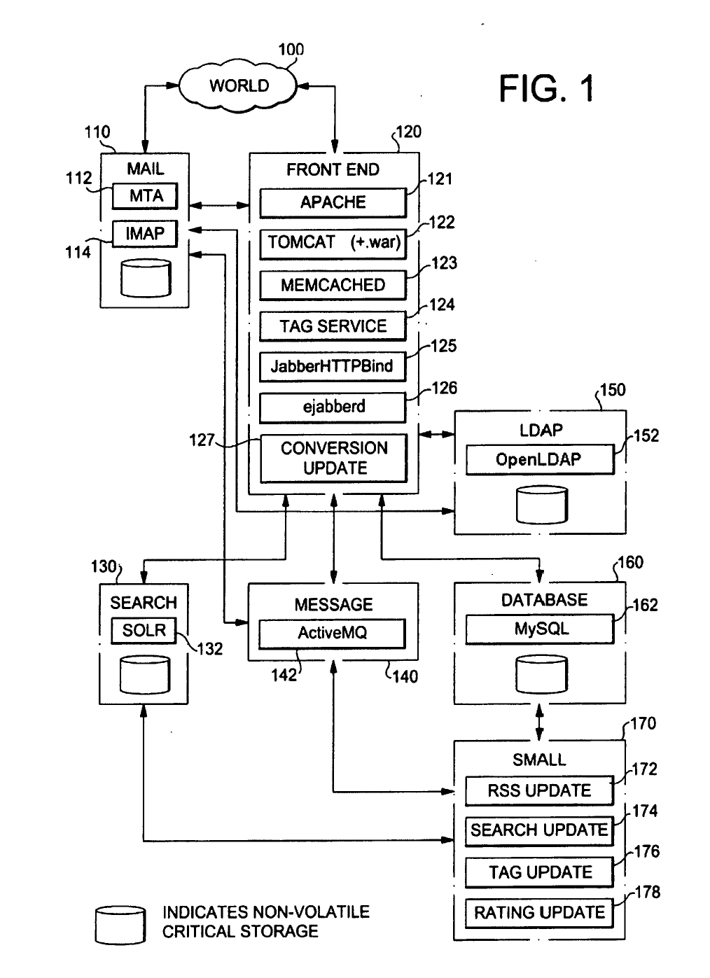

The system includes several subsystems which make up its infrastructure. These subsystems include a number of best-of-breed open source applications that have been customized and integrated to deliver the complete, proprietary web application. As illustrated in FIG. 1, all of these subsystems allow for access via the web 100 or other interactive media. These subsystems include a mail subsystem 110, including an MTA (Mail Transport Agent) 112 and the IMAP (Internet Message Access Protocol) 114 components which support the mail system used in the system. The mail system allows users to send mail from their web-based system mailbox, and receive mail to their system mailbox and a third-party private mailbox like their private email.

Also included is a search subsystem 130 that includes SOLR 132, where SOLR is the Apache Lucene based search system used for searching and indexing all the content in the system. When a user submits a search request, it is passed on to the SOLR 132 which processes the search and returns the result set back to the user's browser through the system application. The system also includes a message subsystem 140, including an ActiveMQ component 142, where the ActiveMQ component is the message queuing server the system uses to queue and distribute messages used to alert users of the system and user instantiated communication, This is experienced by the user in the notifications bar from within the control panel, discussed below, The system also uses the message queue for a variety of back-end communications across the subsystems.

The system also has an LDAP susbsystem 150, including an OpenLDAP component 152. The directory server is used to store user information along with authentication credentials for users to access the system. The directory server works in conjunction with the chat service (ejabberd), mail service (IMAP), web application, and database server (MySQL). That database 160 is another subsystem that uses MySQL 162 as the RDBMS used to store content for the system. This is the data repository where all the user's information and interactions are stored. The system also includes many smaller services 170, which are grouped together in this discussion. These include the RSS Update service 172 which updates RSS feeds in the system that user's have submitted for display within their profile. That allows the integration of user-created content on remote systems such as blogs, or personal websites. The search update service 174 is the mechanism that instantiates search indexing when content is updated by users including profile, tags, blog posts, and conversations. The tag service 176 generates the complete system tag cloud for the entire community. That provides a view to users of the most popular tags in the system. The rating service 178 is used to process the data to determine the rating of an element in the system. The present system uses explicit ratings data supplied by users who have rated an element, and other system metrics to determine the appropriate rating.

The front-end subsystem 120 includes several servers and engines. The Apache server 121 is the web server used to process the user's web browsers requests and is integrated with all the supporting systems in the system. Tomcat 122 is the Java Servlet engine that runs the web application in the server infrastructure. That is the web-based application server responsible for processing all the application logic for the core system. The memcached system 123 is a server-based caching solution used to enhance system performance by keeping a wide variety of commonly used data in a cache to reduce database queries and other redundant data request calls. The tag service 124 uses Wordnet, a semantic lexicon for the English language, to identify tags for content in the system and content on third-party systems that the user has created. Wordnet groups English words into sets of synonyms called synsets, provides short, general definitions, and records the various semantic relations between these synonym sets. That allows the system to generate tags for content in a more sophisticated way than general keyword indexing. The tag service 124 also provides “look ahead” capabilities for users when they are typing in new tags for their profile. That feature suggests tags based on the letters that the user has typed in. The jabberHTTPBind 125 is the Binding agent used in the transport of messages sent from a user's browser to the HTTP Bind service 125 which connects to the ejabberd server 126. Ejabberd is the chat server that supports the real-time chat features in the system including chat room management, multi-person chat, and chat archiving. The conversation update service 127 archives the completed conversations and prepares them for search indexing.

Another aspect of the invention is the rating system. The purpose of the rating system is to increase the effectiveness of search results by sorting elements by their perceived usefulness (as defined by the community). Users are given several opportunities to rate their fellow users using a common “5-star” system. These opportunities include, during a conversation, when viewing a profile, reading a blog post by a user, or reading an archived conversation. All users begin with a status of “no rating” (which is different from zero stars) to ensure a common starting point from which the search engine can make relative determinations.

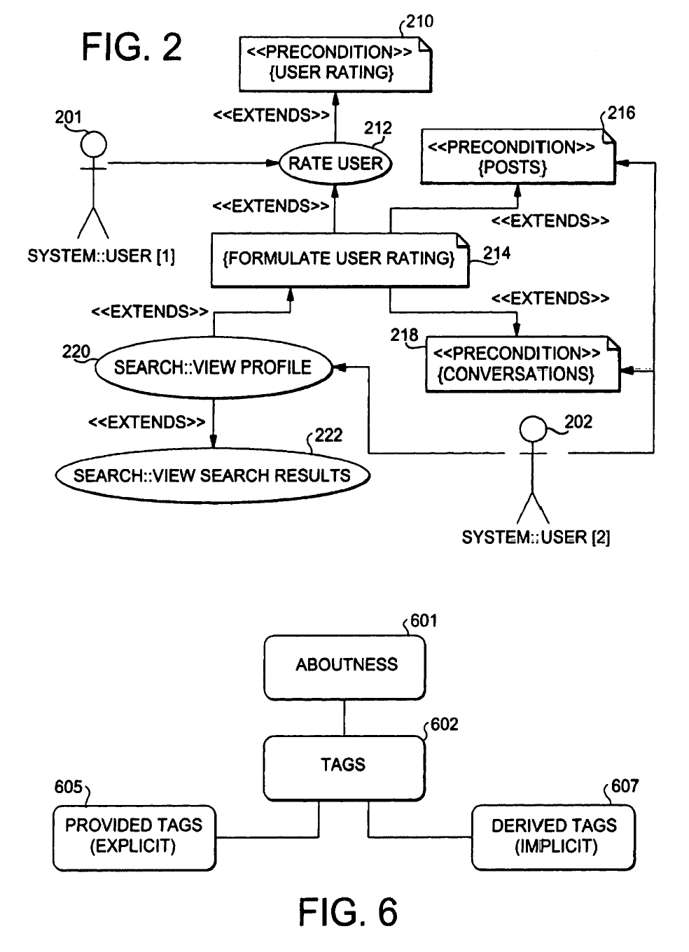

The overall process is illustrated in FIG. 2. A first user 201 can rate another user 202 based on several factors. The initial user rating 210 can be used to rate the user 212, so that a new or revised user rating can be formulated 214. That formulation can be based on posts 216 and conversations 218 by the user 202 being rated. Thereafter, the new or revised rating can be seen in viewing the user's profile 220 and be used to view the search results 222. A user can rate another user multiple times, but only the most recent rating, according to at least one embodiment, will be applied to that user. The updating of the rating is performed via independent services that run at pre-set intervals. The default display of the rating user interface module is either the “no rating” graphic or the current rating shown in stars.

As an example, the user may be in an active conversation, reading a post or archived conversation or viewing another user's profile. The user moves the cursor over the rating interface module and the star graphic “on” or “off” state is displayed as each subsequent star is hovered over. The user clicks on any number of the stars to indicate a rating. The rating user interface module 178 updates the star graphic to display the rating given to the other user, where the rating subsystem records the appropriate rating data.

As discussed above, the ratings associated with search results allow users to better determine which users will be most useful to them. A user executes a search from any page, and the system displays a search results page in default sort order (by relevance). The user clicks the “Rating” sort option (radio button) and the search results page reorders itself by rating from highest (five stars) to lowest (zero stars) and “no rating.”

The User Rating subsystem compiles and maintains a Rating value from 1 to 5 for each user. That value will be updated when predefined system and user activity triggers occur. The system generates the rating from a base value comprised of a weighted average of other user's feedback for that individual, adjusted by additive modifiers based on that individual's activity in the system. The system will calculate a user's rating when the user: completes a post, completes a conversation, or is rated by another user. The rating subsystem calculates the value for each user by way of generating a base rating from other user-provided values and applying rating modifier values calculated by the system.

The following definitions are used. The base rating is the value for a user calculated by a weighted average of other user's feedback incorporating their rating at that time. The rater rating is the rating value a user who is rating someone has at the time of rating submission. The rating granted by rater is the rating that a user provides for a searcher based on the personal experience of that user. The Base Rating is calculated using the average weighted rating supplied by other users. When a user does not have a base rating, the system will not maintain a display rating for the user (the user is “not yet rated”). Once the first user Rating has been granted by a rater, the system will generate the Base Rating using the following algorithms:

Individual Weighed Rating=Rater Rating*Rating Granted by Rater

User Base Rating=Sum of all Weighted Rating/Sum of Rater Rating

The Base Rating is calculated using the average weighted rating supplied by other users. The system has been designed to utilize rating modifiers which can be positive (additive), or negative (subtractive) in nature. In certain embodiments, the system supports two additive modifiers based on the following: number of posts and the number of completed conversations. The purpose of these modifiers is to reward users based on content creation and interactions which in turn, adds content and experience richness to the system. The “Number of Posts” rating modifier is calculated by measuring the uniform distribution of the number of Posts generated by that user, on a scale comprised of the average Posts by all users and the number of Posts by the highest Posting user(s). The user can receive up to 0.75 points based on this calculation. Users with fewer Posts than the average user receive a rating modifier of zero.

The ‘Number of Completed Conversations’ modifier is similarly calculated to the number of Posts modifier constraining the data set to activities of the last 60 days. The system generates the value by measuring the uniform distribution of the user's completed conversations, on a scale of the average number of completed conversations by all users and the highest number of completed conversations for a user for the specified period. The user can receive up to 0.75 points based on this calculation. Users with fewer completed conversations than the average user receive a rating modifier of zero. The system uses the values for highest and average Posts and completed conversations to calculate rating modifiers. Those values will be generated once daily and stored in a system statistics cache for use when calculating the necessary values.

The purpose of the control panel is to provide a unified interface for the following: logging in or out of the system, displaying and interacting with notifications to the user, including requests to join a conversation, notifications of new email, and other system notifications, manage the availability (Available or Not Available) of the user and spawning the control panel into a new, smaller pop-up browser window. The control panel resides at the top of each page, above the header. It has the ability to expand (pushing the rest of the page elements down) to display more information at once.

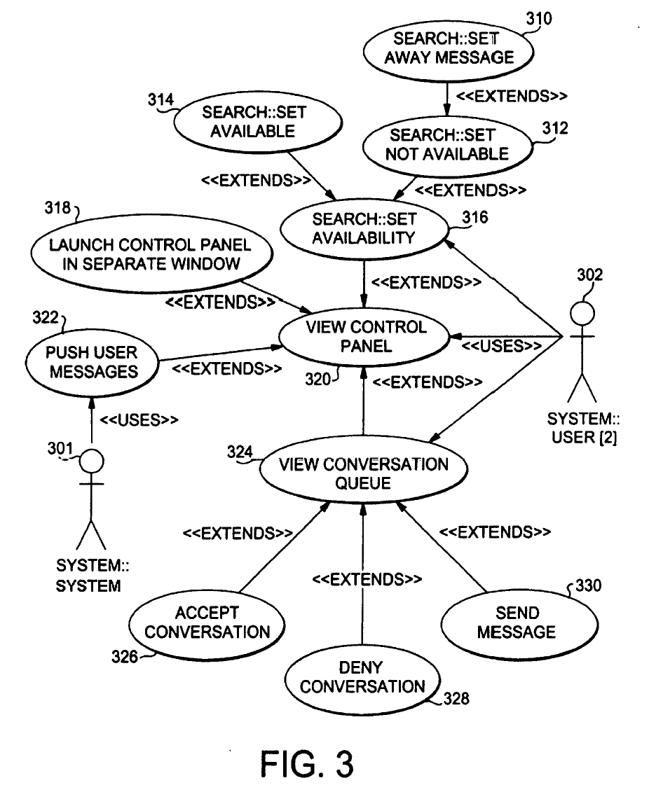

The use of the control panel is illustrated in FIG. 3. A user 302 and the system 301 use the control panel to present 320 and allow for adjustment of information. The control panel allows the user 302 to set his/her availability 316, where it can be set to available 314, or not available 312, where the latter can also be set to provide an away message 310, when the user is away. As discussed above, the control panel can be launched into a separate window 318 to allow specific access to the user.

The control panel also allows the user 302 to view the conversation queue 324, where a conversation can be accepted 326, denied 328 and messages for conversations can be sent therefrom 330. Generally, a user needs to be invited to participate in a conversation and must accept that invitation to join. The control panel also allows a user message to be pushed to the user 302 by the system for easy access. The control panel also allows the user to log into the system or log out, thus creating or ending a session.

Another aspect of the invention is the serving elements of the system based on presence. These elements can be ads in the sense of advertisements that promote a user or an area of the user's business or interests. These elements could be other mechanisms that allow the user's points of emphasis to be presented when the user is available or willing to advocate for those points of emphasis. The purpose of ad serving based on presence is to allow a specific user to promote their availability and their knowledge of a particular topic to a user as a result of a specific search. Users may purchase keywords and phrases to enable this serving of elements.

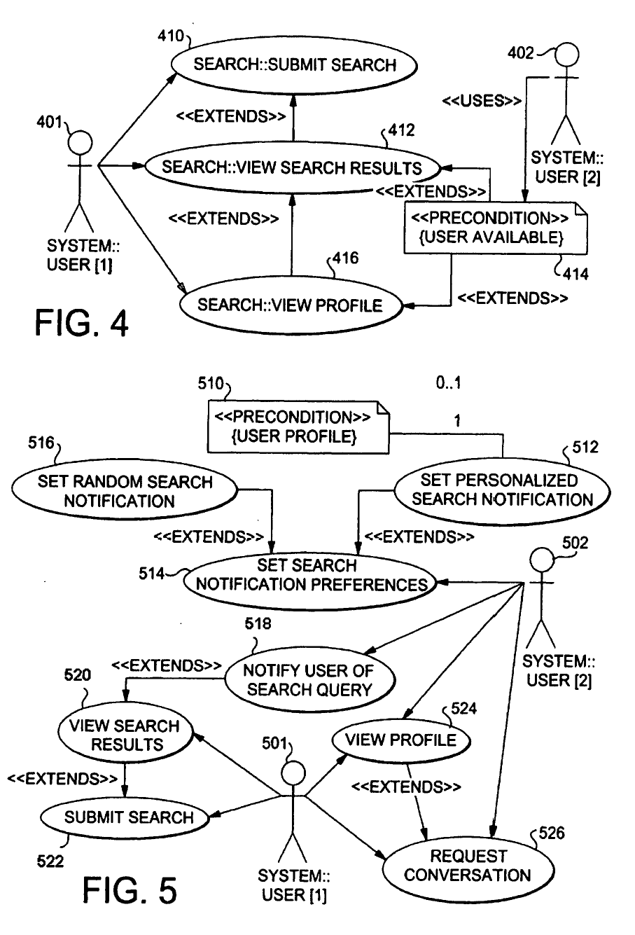

FIG. 4 illustrates the process of serving elements. A user 402 has a point of emphasis, such as an expertise, knowledge on particular topics and/or availability to accept queries and/or conversations from other users. Those points of emphasis are made to the system 414 by the user 402 wishing to advertise their points of emphasis. Thereafter, when another user 401 submits a search 410, the search results 412 will include elements that point out the points of emphasis for the first user 402, if appropriate. Additionally, those points of emphasis can also be illustrated for the first user 402 when someone views the profile for that user.

The process of purchasing specific search terms to allow for the serving of elements can be accomplished through the control panel. Thereafter, when a subsequent user performs a search using a keyword allocated to the first user, the system associates the search term with the keyword. The system determines the first user's availability or other attribute used to initiate the service, and displays an ad or other element if the first user is available or if the other attribute is met. Thereafter, the second user can interact with the element, where that interaction is recorded by the system.

Another aspect of the invention is directed to search monitoring. The purpose of reverse search monitoring is to better connect searchers with the specific users that know about the topic being searched for. Users may watch an interactive display of searches taking place in near-real time. Clicking on any of the searches leads to the profile page of the searcher. The search terms shown in the interactive display are able to be queued for a configurable number of minutes to ensure a sufficient number of terms to initially populate the display. In specific embodiments, only searches submitted by logged-in users will be included in the reverse search monitoring functionality.

Additionally, it is possible to further filter the search terms displayed to only those that match the profile of the user viewing the reverse search monitoring display. For example, if a user knows about baseball, salsa dancing, and barbecuing, he/she will only see searches that conform to those interests.

A method for adding search terms to the reverse search monitoring queue in near-real time occurs when a first user 501 enters search terms 522 and clicks the “Search” button. Search results 520 are returned to the user and the search term is added to the reverse search monitoring message queue 518. The message queue listener adds the most recent search term to the interactive display. The second user 502 monitors that queue, based on notification preferences 514 set by the second user. Those include setting a random search notification 516 or setting a personalized search notification 512, based on the user's profile 510.

The second user 502 can contact the original searcher from the reverse search monitoring interactive display 518. The second user 502 clicks on the search term that the first user 501 entered when it is displayed in the interactive display. The system returns to the second user 502 the profile page 524 of the first user 501. The second user 502 may get in touch with the first user 501 to discuss the topic of the search 526. Additionally, in other embodiments, the system may implement restrictions so that the privacy of the original searcher may be maintained. In such embodiments, second user may be given a mechanism to allow them to contact the first user without knowing his/her identity, with the choice of contacting the second user left with the first user.

The present invention is directed to a system which allows for the archiving, indexing, and making searchable the whole of human insight and experience. The system analyzes whatever it is given about the user and makes this information manageable by the user. The User Profile contains at least the following manageable attributes about each user: account settings, introductory information, a photo, thoughts/blog/posts, a rating, tags, provided tags and derived tags.

The system supports at least two types of tags: provided and derived. As illustrated in FIG. 6, the provided tags 605 and the derived tags 607 are portions of the overall tags 602 that can be assigned using the system. Provided tags may be input manually by the user while derived tags are automatically generated by a Concept Extraction engine. Examples of sources for derived tags include public blogs, web pages, conversations and posts on the system, forums or listserv entries, email or Instant Message conversations and social networking sites.

The process of adding a tag can be as follows. Once a user is logged in, the user begins typing a tag into a text box on the Edit Profile page. As the user types, the system tries to predict the final tag by displaying suggestions below the text box. The user a) finishes typing the tag, or b) chooses a complete tag from the list of suggestions. Thereafter, the system adds the new tag to the user's profile where it will be indexed by the search engine and displayed on their profile page.

The system allows users to decide when and how they want to be found. The availability service manages connections to their various presences on other sites. The availability rules service allows users to configure how other users can contact them. For example, User 1 attempts to contact User 2 via a “Talk Now” button. The system intercepts the request and determines User 2's preferred method of contact given the availability rules set by User 2. The system directs the talk request to User 2's preferred method of contact. User 1 is notified that User 2 has been notified of the request to talk. User 2 receives the request and clicks on the embedded link to log into the system and initiate the chat session.

Additionally, the content of the interactions between users is captured and that new content is integrated into the search indices so that the overall knowledge base is extended in an automated fashion. Thus, if a first and second user communicate, as discussed above, about a particular topic, the content of their communication goes back into the system to allow for the indexing of search terms to be extended. For example, if users are conversing about baseball and they mention a specific baseball team or park, those mentions can be fed back into the system with either user could be used as a resource about the mentioned topic.

Additional aspects of the invention also include measures that prevent the rating system from being “gamed,” such that a user can raise their rating by particular behaviors that are outside the normal operating parameters for users. The present invention also provides for age verification and parental consent policies that are required for all online entities. Additionally, while chat has been discussed as one means for facilitating interactions between users, the present system also integrates instant messaging and voice-over-IP functionalities to also facilitate communications between users.

While a preferred embodiment has been set forth in detail above, those skilled in the art will readily appreciate that other embodiments can be realized within the scope of the invention. For example, numerical values are illustrative rather than limiting, as is the order in which steps are carried out, Therefore, the present invention should be construed as limited only by the appended claims.

What is claimed is:

1. A method of searching for information on a network, comprising the steps of:
receiving a search query from a user by a search system;
processing the search query by a profile engine of the search system;
providing a listing of search results, including personas who know about the search query, based on profiles and posts of the personas, where the personas are users of the search system;
facilitating further interaction with the listing of personas and tags for related content.

2. The method of searching for information on a network as recited in claim 1, wherein the step of providing the listing of personas comprises providing a listing of personas ranked by computed relevance to the search query.

3. The method of searching for information on a network as recited in claim 1, wherein the step of providing the listing of personas comprises providing a listing of personas ranked by presence statuses of the personas in the listing of personas.

4. The method of searching for information on a network as recited in claim 1, further comprising providing a relevant listing of posts of the personas relevant to the search query.

5. The method of searching for information on a network as recited in claim 1, further comprising the steps of:
awaiting a selection of a particular persona from the listing of personas by the user; and
displaying information and contact actions for the particular persona to the user.

6. The method of searching for information on a network as recited in claim 5, wherein the contact actions comprise at least one of chat, instant messaging, voice-over-IP and telephonic communication.

7. The method of searching for information on a network as recited in claim 1, further comprising providing an interactive rating listing for the found personas to allow the user to rate a particular persona.

8. The method of searching for information on a network as recited in claim 1, further comprising serving the user with an ad that promotes attributes of a particular persona based on the search query.

9. The method of searching for information on a network as recited in claim 8, wherein the attributes of the particular persona comprise at least one of availability of the particular persona and specific knowledge of the particular persona.

10. The method of searching for information on a network as recited in claim 1, wherein the step of facilitating further interaction comprises integrating portions of an interaction between the user and a persona into a search index of the search system.

11. The method of searching for information on a network as recited in claim 1, further comprising providing information about the search query and the listing of search results to a persona based on pre-selected criteria setup by the persona.

12. A computer program product, embodied on a computer-readable medium, comprising instructions for performing the steps of,
receiving a search query from a user by a search system;
processing the search query by a profile engine of the search system;
providing a listing of search results, including personas who know about the search query, based on profiles and posts of the personas, where the personas are users of the search system;
facilitating further interaction with the listing of personas and tags for related content.

13. The computer program product as recited in claim 12, further comprising providing an interactive rating listing for the found personas to allow the user to rate a particular persona.

14. The computer program product as recited in claim 12, further comprising serving the user with an element that promotes attributes of a particular persona based on the search query.

15. The computer program product as recited in claim 14, wherein the element comprises an ad promoting the particular persona.

16. The computer program product as recited in claim 14, wherein the attributes of the particular persona comprise at least one of availability of the particular persona and specific knowledge of the particular persona.

17. A system providing a user with the ability to search for information on a network, comprising:
an interface for receiving a search query from a user and for providing a listing of search results back to the user;
a search processor configured to process the search query through a profile engine;
a database, including a listing of personas who are users of the system and attributes of the personas, based on profiles and posts of the personas; and
an interaction mediator, which facilitates interaction between user performing the search query and the personas;
wherein the search results comprises a listing of personas who know about the subject of search query and tags for related content.

18. The system as recited in claim 17, wherein the listing of personas comprises a listing of personas ranked by presence statuses of the personas in the listing of personas.

19. The system as recited in claim 17, wherein the listing of personas comprises a relevant listing of posts of the personas relevant to the search query.

20. The system as recited in claim 17, wherein the interaction mediator is configured to mediate communication based on at least one of chat, instant messaging, voice-over-IP and telephonic communication.

21. The system as recited in claim 17, wherein the interface is further configured to provide an interactive rating listing for the found personas to allow the user to rate a particular persona.

22. The system as recited in claim 17, wherein the interface is further configured to serve the user with an ad that promotes attributes of a particular persona based on the search query.

23. The system as recited in claim 22, wherein the attributes of the particular persona comprise at least one of availability of the particular persona and specific knowledge of the particular persona.

24. The system as recited in claim 17, further comprising means for providing information about the search query and the listing of search results to a persona based on pre-selected criteria setup by the persona.

25. The system as recited in claim 17, wherein the interface further comprises a control panel module that allows the user to display notifications to other users and mange availability of the user.
